(19) United States
(12) Patent Application Publication
(10) Pub. No.: US 2007/0018551 A1
(43) Pub. Date: Jan. 25, 2007

(54) Gap-wound filament array and lamps using same

(76) Inventors: Francis Gerard Decort, Leicester (GB); Andrew Davies, Hinckley (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/491,847

(22) Filed: Jul. 24, 2006

(30) Foreign Application Priority Data
Jul. 25, 2005 (GB) 0515215.2

(51) Int. Cl. H01K 1/26; H01J 5/16; H01J 61/40; H01K 1/30

(52) U.S. Cl. 313/115

(57) ABSTRACT

A filament array for an incandescent lamp comprises a plurality of helically-coiled filament sections (4-11) which are arranged in one or more parallel planes. At least some (6, 7, 8 and 9) of the filament sections have gap-wound portions (22, 23, 24 and 25), the gap-wound portions being arranged to provide an area (26) in the plane or planes of the array through which light can pass.

This invention relates to incandescent lamps, and in particular to those lamps which utilise filament arrays of the planar type. Well-known filament formats include the single-coil monoplane (C13) and the single coil biplane (C13D). Such filaments comprise a multiplicity of helically-wound coils arranged substantially parallel with each other. Subsets of such coils are then arranged in a series of one or more planes, hence the terminology “monoplane, biplane” etc.

It is common for lamps using filaments of the planar type to be employed in illumination systems where a reflector is placed directly behind the filament in order to redirect rearwardly-transmitted light in a forward direction in order to increase the overall system efficiency. However, a well-known problem with such systems is that the filament, placed as it is in front of the reflector, is in the path of the reflected light and therefore prevents a substantial proportion of that light from being usefully employed.

Attempts have been made to increase the efficiency of illumination systems of this type. For example, U.S. Pat. No. 5,235,499 describes an illumination system with two novel features: firstly a torroidally-shaped filament is employed with a central space through which reflected light can pass; secondly, a reflector design is disclosed which reflects a substantial proportion of the light it receives through the central space in the filament. However, a torroidal filament is difficult to manufacture and support using known techniques.

It is an object of the present invention to improve the system efficiency of planar filament arrays.

According to the present invention, there is provided a filament array for an incandescent lamp comprising a plurality of helically-coiled filament sections, the sections being arranged in one or more parallel planes, characterised in that at least some of the filament sections have gap-wound portions, the gap-wound portions being arranged to provide an area in the plane or planes of the array through which light can pass.

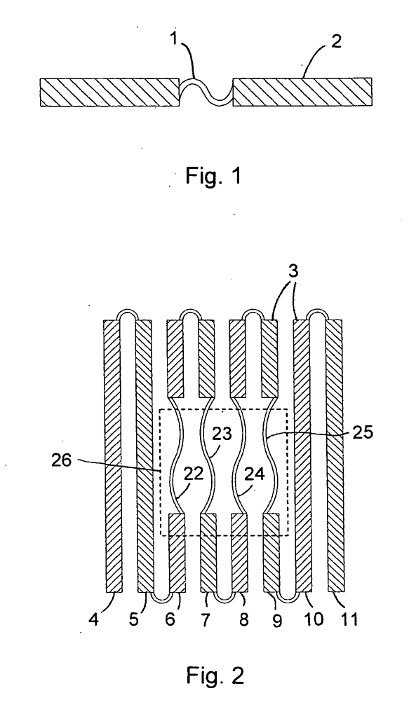

In the lighting industry, the technique of “gap-winding” is well-known, and can be understood by referring to FIG. 1. This is the technique of introducing into a helically-wound filament coil one or more turns 1 which have a substantially larger pitch than the remainder of the coil 2. Such gap-wound sections can be observed in a number of commercial products, for example the HPL range of lamps manufactured by GE Lighting. Gap-winding is typically used to aid manufacturing processes, for example to provide a “marker” position where a coil has to be trimmed or shaped, or in the case of the HPL lamps, to indicate the position where the ends of the coil are to be shorted to, thus accurately controlling the active length of coil in the filament.

In the present invention, use is made of the gap-winding technique to impart dimensional properties to the filament which offer optical advantages when used in conjunction with certain optical systems.

This invention, therefore, addresses the continued need for lighting systems with improved efficiencies. Such systems are used in a variety of applications, for example film and TV studio lighting, theatre lighting, and retail and architectural lighting.

Embodiments of the invention will now be described, by way of example, with reference to the accompanying drawings, in which:

FIG. 1 is a diagrammatic view of a gap wound filament portion joining two standard helically wound filament sections;

FIG. 2 is a filament array with a rectangular area defined by the gap-wound portions;

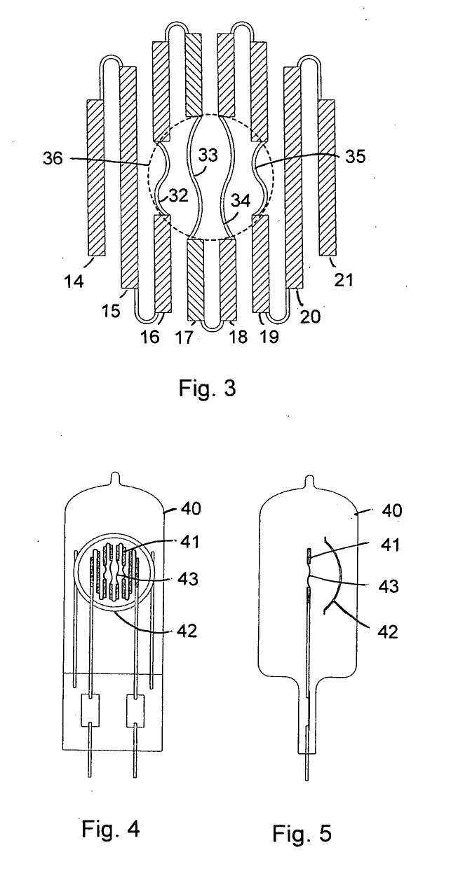

FIG. 3 is a filament array with a circular area defined by the gap-wound portions; and

FIGS. 4 and 5 show a front elevation and cross-section of a lamp including a filament array according to the invention and a reflector.

The invention may be conveniently described with reference to FIG. 2. This is a schematic view of a filament array in accordance with the invention. In this example, a monoplane filament array is shown. The array comprises a multiplicity of helically wound filament sections 3 arranged substantially parallel with each other, and also arranged such that they form a planar arrangement of overall rectangular shape. In this example, eight filament sections are present, although it is possible to have any number of sections present in the array down to a minimum of three. The filament sections have been labelled 4 to 11 from left to right as the filament array is viewed.

It will be seen that outer sections 4, 5, 10 and 11 are continuous helically-wound coils with a constant, uninterrupted pitch, whereas the pitch of inner sections 6, 7, 8 and 9 are interrupted by a portion of open pitch. In this example sections 6, 7, 8 and 9 are interrupted by single open turns 22, 23, 24 and 25 respectively, which have been manufactured using gap-winding. It will be seen that the overall effect is that of a filament array with a central, generally square-shaped space 26 through which reflected light can easily pass. Therefore, when used in conjunction with a suitable reflector, this filament array will allow more light to be projected forwards towards its desired location than can be achieved with traditional monoplane or biplane filament arrays.

A further embodiment of this invention can be conveniently described with reference to FIG. 3. Here, eight filament sections, labelled 14-21, are again present. However, in this case the filament sections are of unequal length, arranged such that the overall shape of the array resembles a circle. This is a desirable filament shape when the light emitted by the filament is intended to be transmitted through a circular aperture such as that found in Fresnel or condenser optics. Again, inner sections 16, 17, 18 and 19 have gap-wound open turns 32, 33, 34, and 35 which interrupt the regular pitch of the coil. In this case, the gaps are of irregular length such that the space 36 for light transmission is also substantially circular in appearance.

The filament array may comprise one or more planes, and there is no limit to the number of planes which may exist in the array. Any number of filament sections may contain gap-wound open turns.

In an embodiment of the invention, the filament array is mounted in a lamp with an integral reflector. FIGS. 4 and 5 show an example of such an embodiment in front elevation and in cross section. In this example, the lamp 40 contains a filament array 41 of the kind shown in FIG. 3, positioned in front of a reflector 42. The central filament sections contain gap wound open turns. 43. In accordance with the invention, the other, outer, filament sections may be continuous single-pitch sections. It will be understood that the reflector 42 in this embodiment is designed so as to reflect a substantial proportion of the light through the space created by the gap-wound open turns.

1. Filament array for an incandescent lamp comprising a plurality of helically-coiled filament sections, the sections being arranged in one or more parallel planes, characterised in that at least some of the filament sections have gap-wound portions, the gap-wound portions being arranged to provide an area in the plane or planes of the array through which light can pass.

2. The filament array of claim 1 wherein the filament sections in the or each plane are substantially parallel with one another.

3. A lamp comprising a filament array according to claim 1 and a reflector, the array and reflector being positioned such that light reflected by the reflector passes through the area of the array defined by the gap-wound portions.
